(19) United States
(12) Patent Application Publication
(10) Pub. No.: US 2015/0264286 A1
(43) Pub. Date: Sep. 17, 2015

(54) SOLID-STATE IMAGING DEVICE

(71) Applicant: Kabushiki Kaisha Toshiba, Minato-ku (JP)

(72) Inventor: Hiroaki YAMAOKA, Setagaya (JP)

(73) Assignee: Kabushiki Kaisha Toshiba, Minato-ku (JP)

(21) Appl. No.: 14/455,078

(22) Filed: Aug. 8, 2014

(30) Foreign Application Priority Data
Mar. 14, 2014 (JP) 2014-051764

(51) Int. Cl. H04N 5/369; H04N 5/378; H04N 5/225

(52) U.S. Cl. CPC H04N 5/369; H04N 5/225; H04N 5/378

(57) ABSTRACT

According to one embodiment, a solid-state imaging device includes a pixel array unit in which pixels for accumulating photoelectric-converted charges are arranged in a matrix of a row direction and a column direction; and a vertical scanning circuit in which drivers for driving the pixels are dispersed in each of rows.

### CROSS-REFERENCE TO RELATED APPLICATIONS

This application is based upon and claims the benefit of priority from Japanese Patent Application No. 2014-51764, filed on Mar. 14, 2014; the entire contents of which are incorporated herein by reference.

### FIELD

Embodiments described herein relate generally to a solid-state imaging device.

### BACKGROUND

In a solid-state imaging device, the number of pixels has increased with higher resolution, and the wires for driving the pixels have become longer in distance. Meanwhile, drivers driving the pixels are arranged at an end portion of a pixel array unit, and thus an increasing load has been applied to the drivers, thereby leading to a longer driving time.

### BRIEF DESCRIPTION OF THE DRAWINGS

FIG. 1 is a schematic block diagram of a solid-state imaging device according to a first embodiment;

FIG. 2 is a circuit diagram illustrating a configuration example of a pixel in the solid-state imaging device illustrated in FIG. 1;

FIG. 3 is a perspective view of one example of a layered structure in the solid-state imaging device illustrated in FIG. 1;

FIG. 4 is a timing chart illustrating voltage waveforms of respective components during reading of the pixels illustrated in FIG. 1;

FIG. 5 is a block diagram of one example of a layered structure of one line of the pixel array unit and a vertical scanning circuit in the solid-state imaging device illustrated in FIG. 1;

FIG. 6 is a block diagram of a modification example of the layered structure illustrated in FIG. 5;

FIG. 7 is a block diagram of one example of a layered structure of one line of a pixel array unit and a vertical scanning circuit in a solid-state imaging device according to a second embodiment;

FIG. 8 is a block diagram of a modification example of the layered structure illustrated in FIG. 7;

FIG. 9 is a schematic block diagram of a solid-state imaging device according to a third embodiment;

FIG. 10 is a block diagram of one example of a layered structure of one line of a pixel array unit and a vertical scanning circuit in the solid-state imaging device illustrated in FIG. 9;

FIG. 11 is a block diagram of a modification example of the layered structure illustrated in FIG. 10; and

FIG. 12 is a schematic block diagram of a digital camera to which a solid-state imaging device according to a fourth embodiment is applied.

### DETAILED DESCRIPTION

In general, according to one embodiment, a solid-state imaging device includes a pixel array unit and a vertical scanning circuit. The pixel array unit has pixels accumulating photoelectric-converted charges arranged in a matrix of a row direction and a column direction. The vertical scanning circuit has drivers for driving the pixels dispersed in each of rows.

Exemplary embodiments of the solid-state imaging device will be explained below in detail with reference to the accompanying drawings. The present invention is not limited to the following embodiments.

### First Embodiment

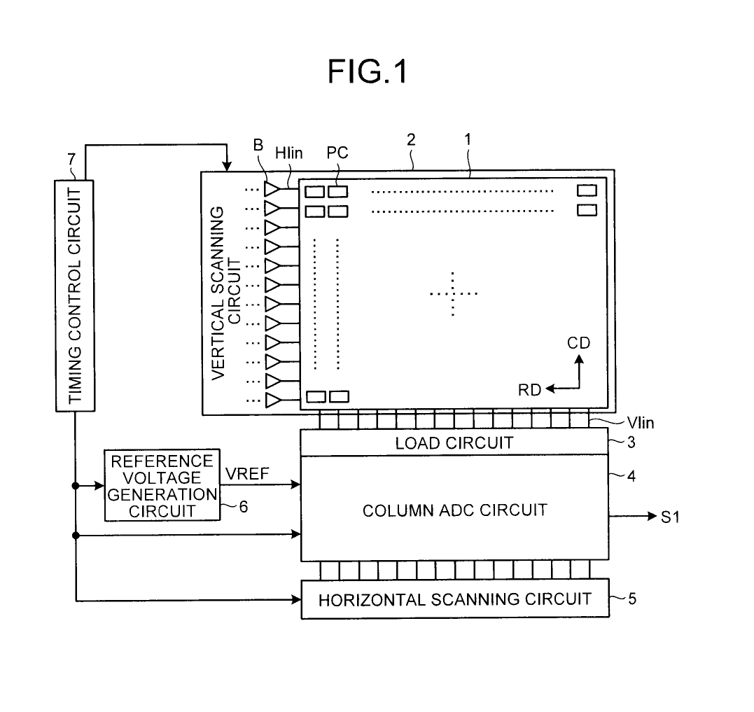

FIG. 1 is a schematic block diagram of a solid-state imaging device according to a first embodiment.

Referring to FIG. 1, the solid-state imaging device is provided with a pixel array unit 1. The pixel array unit 1 has pixels PC for accumulating photoelectric-converted charges arranged in a matrix of m (m is a positive integer) rows by n (n is a positive integer) columns in row direction RD and column direction CD. The pixel array unit 1 is also provided with horizontal drive wires Hlin for driving the pixels PC in the row direction RD and vertical signal wires Vlin for transmitting signals read from the pixels PC in the column direction CD.

In addition, the solid-state imaging device is provided with a vertical scanning circuit 2 that vertically scans the pixels PC to be read; a load circuit 3 that performs a source follower operation between the circuit and the pixels PC to read pixel signals from the pixels PC in each of the columns into the vertical signal wires Vlin; a column ADC circuit 4 that detects by CDS signal components of the pixels PC in each of the columns; a horizontal scanning circuit 5 that horizontally scans the pixels PC to be read; a reference voltage generation circuit 6 that outputs a reference voltage VREF to the column ADC circuit 4; and a timing control circuit 7 that controls reading of the pixels PC and timing of accumulation. The vertical scanning circuit 2 has drivers B for driving the pixels PC dispersed in each of the rows. A plurality of drivers B can be inserted into each of the horizontal drive wires Hlin. At that time, the pixel array unit 1 can be stacked on the vertical scanning circuit 2 to provide the drivers B under the pixel array unit 1.

Then, when the pixels PC are vertically scanned by the vertical scanning circuit 2, the pixels PC are selected in the row direction RD and the pixels PC are driven in each of the rows via the drivers B. Then, at the load circuit 3, a source follower operation is performed with the pixels PC to transmit pixel signals read from the pixels PC via the vertical signal wires Vlin and sent the same to the column ADC circuit 4. In addition, at the reference voltage generation circuit 6, a ramp wave is set as reference voltage VREF and sent to the column ADC circuit 4. Then, at the column ADC circuit 4, a clock count operation is performed until the signal level and the reset level read from the pixels PC agree with the level of the ramp wave, and a difference is determined between the signal level and the reset level at that time to detect the signal components of the pixels PC by CDS, and outputs the same as an output signal S1.

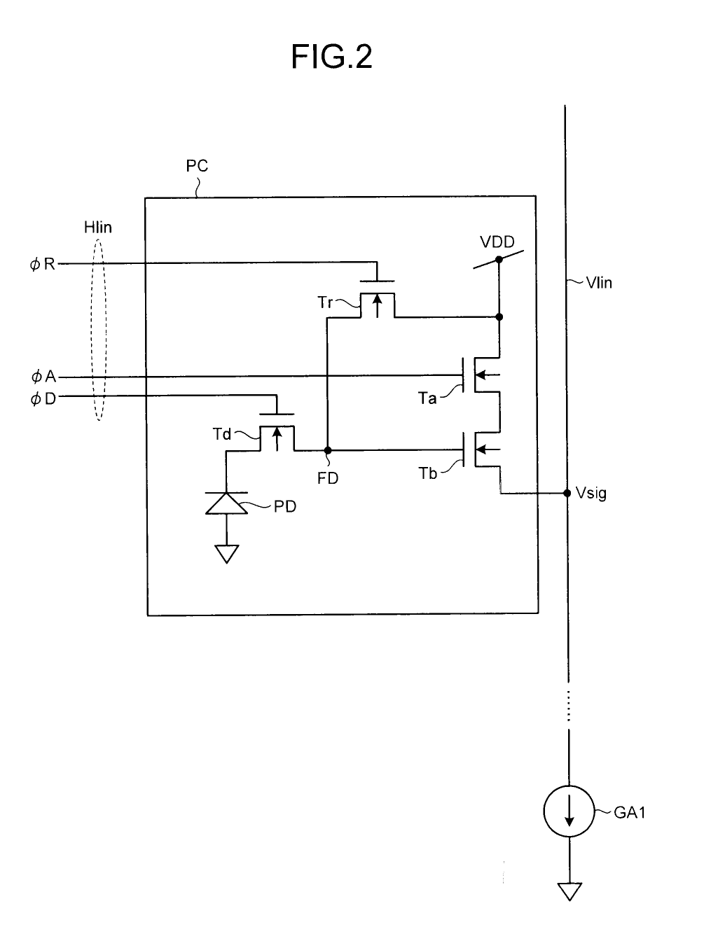

FIG. 2 is a circuit diagram illustrating a configuration example of a pixel in the solid-state imaging device illustrated in FIG. 1.

Referring to FIG. 2, each of the pixels PC is provided with a photodiode PD, a row selection transistor Ta, an amplification transistor Tb, a reset transistor Tr, and a read transistor Td. A floating diffusion FD is formed as a detection node at a connection points of the amplification transistor Tb, the reset transistor Tr, and the read transistor Td.

In each of the pixels PC, a source of the read transistor Td is connected to the photodiode PD, and a read signal ΦD is input to a gate of the read transistor Td. In addition, a source of the reset transistor Tr is connected to a drain of the read transistor Td, and a reset signal TR is input to a gate of the reset transistor Tr. A drain of the reset transistor Tr is connected to a power source potential VDD. A line selection signal TA is input to a gate of the row selection transistor Ta, and a drain of the row selection transistor Ta is connected to the power source potential VDD. A source of the amplification transistor Tb is connected to the vertical signal wire Vlin, a gate of the amplification transistor Tb is connected to a drain of the read transistor Td, and a drain of the amplification transistor Tb is connected to a source of the row selection transistor Ta. The horizontal drive wires Hlin illustrated in FIG. 1 are capable of transmitting the read signal TD, the reset signal TR, and the row selection signal TA to the pixels PC in each of the rows. The load circuit 3 illustrated in FIG. 1 is provided with a constant current source GA1 in each of the columns, and the constant current sources GA1 are connected to the vertical signal wires Vlin.

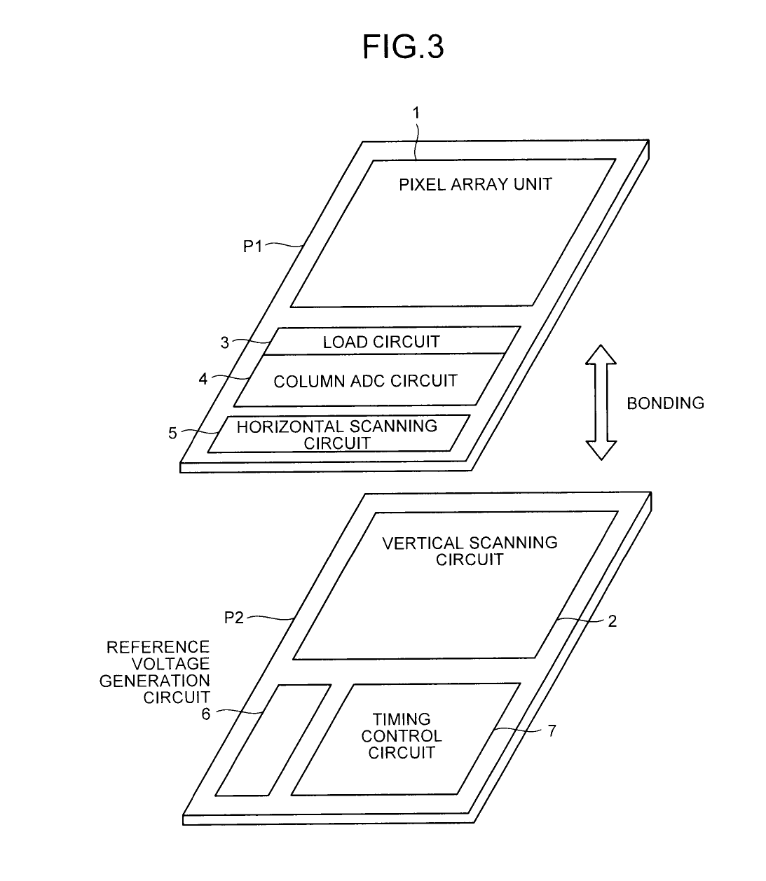

FIG. 3 is a perspective view of one example of a layered structure in the solid-state imaging device illustrated in FIG. 1.

Referring to FIG. 3, a semiconductor chip P1 is provided with the pixel array unit 1, the load circuit 3, the column ADC circuit 4, and the horizontal scanning circuit 5. A semiconductor chip P2 is provided with the vertical scanning circuit 2, the reference voltage generation circuit 6, and the timing control circuit 7. The semiconductor chip P1 is stacked or placed on the semiconductor chip P2. At that time, the semiconductor chip P1 may be bonded to the semiconductor chip P2. The pixel array unit 1 may be arranged so as to overlap the vertical scanning circuit 2. In addition, forming a penetration electrode on the semiconductor chip P1 makes it possible to connect together the pixel array unit 1 and the vertical scanning circuit 2.

In the example of FIG. 3, the load circuit 3, the column ADC circuit 4, and the horizontal scanning circuit 5 are provided on the semiconductor chip P1. Alternatively, the load circuit 3, the column ADC circuit 4, and the horizontal scanning circuit 5 may be provided on the semiconductor chip P2.

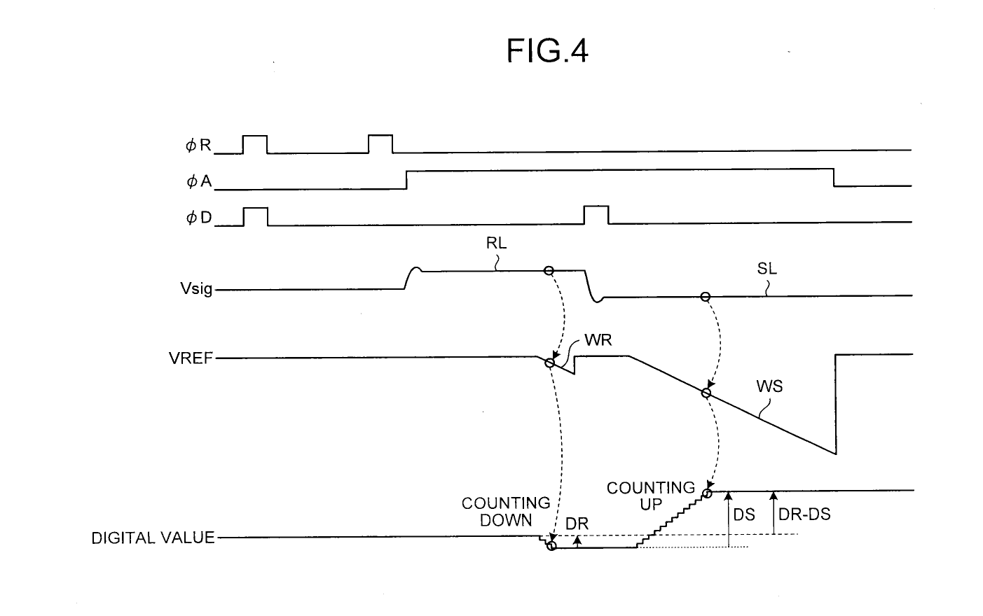

FIG. 4 is a timing chart illustrating voltage waveforms of respective components during reading of the pixels illustrated in FIG. 1.

Referring to FIG. 4, in the case where the row selection signal ΦA is in low level, the row selection transistor Ta is in off state and does not perform a source follower operation, and thus no signal is output to the vertical signal wires Vlin. If the read signal ΦD and the reset signal ΦR become high, the read transistor Td is turned on to discharge charges accumulated in the photodiode PD to the floating diffusion FD. Then, the charges are discharged to the power source potential VDD via the reset transistor Tr.

After the charges accumulated in the photodiode PD are discharged to the power source potential VDD, when the read signal ΦD enters into low level, the photodiode PD starts to accumulate effective signal charges.

Next, when the reset signal ΦR rises, the reset transistor Tr is turned on to reset excessive charges generated due to leak current or the like in the floating diffusions FD.

Then, when the row selection signal ΦA becomes high, the row selection transistor Ta of the pixels PC is turned on, and the power source potential VDD is applied to the drain of the amplification transistor Tb to configure a source follower by the amplification transistor Tb and the constant current source GA1. Then, the voltage corresponding to a reset level RL of the floating diffusion FD is applied to the gate of the amplification transistor Tb. Here, since the source follower is formed by the amplification transistor Tb and the constant current source GA1, the voltage of the vertical signal wire Vlin follows the voltage applied to the gate of the amplification transistor Tb, and a pixel signal Vsig of the reset level RL is output to the column ADC circuit 4 via the vertical signal wire Vlin.

At that time, a ramp wave WR is given as reference voltage VREF, and the pixel signal Vsig of the reset level RL and the reference voltage VREF are compared. Then, the pixel signal Vsig of the reset level RL is counted down until the level of the pixel signal Vsig agrees with the level of the reference voltage VREF, so that the pixel signal Vsig of the reset level RL is converted into a digital value DR and held as such.

Next, when the read signal OD rises, the read transistor Td is turned on, and the charges accumulated in the photodiode PD are transferred to the floating diffusion FD, such that the voltage according to a signal level SL of the floating diffusion FD is applied to the gate of the amplification transistor Tb. Here, since the source follower is formed by the amplification transistor Tb and the constant current source GA1, the voltage of the vertical signal wire Vlin follows the voltage applied to the gate of the amplification transistor Tb, and the pixel signal Vsig of the signal level SL is output to the column ADC circuit 4 via the vertical signal wire Vlin.

At that time, a ramp wave WS is given as reference voltage VREF, and a pixel signal Vsig of the signal level SL and the reference voltage VREF are compared. Then, the pixel signal Vsig of the signal level SL is counted up until the level of the pixel signal Vsig agrees with the level of the reference voltage VREF, whereby the pixel signal Vsig of the signal level SL is converted into a digital value DS. Then, a difference DR-DS between the pixel signal Vsig of the reset level RL and the pixel signal Vsig of the signal level SL is held and output as an output signal S1.

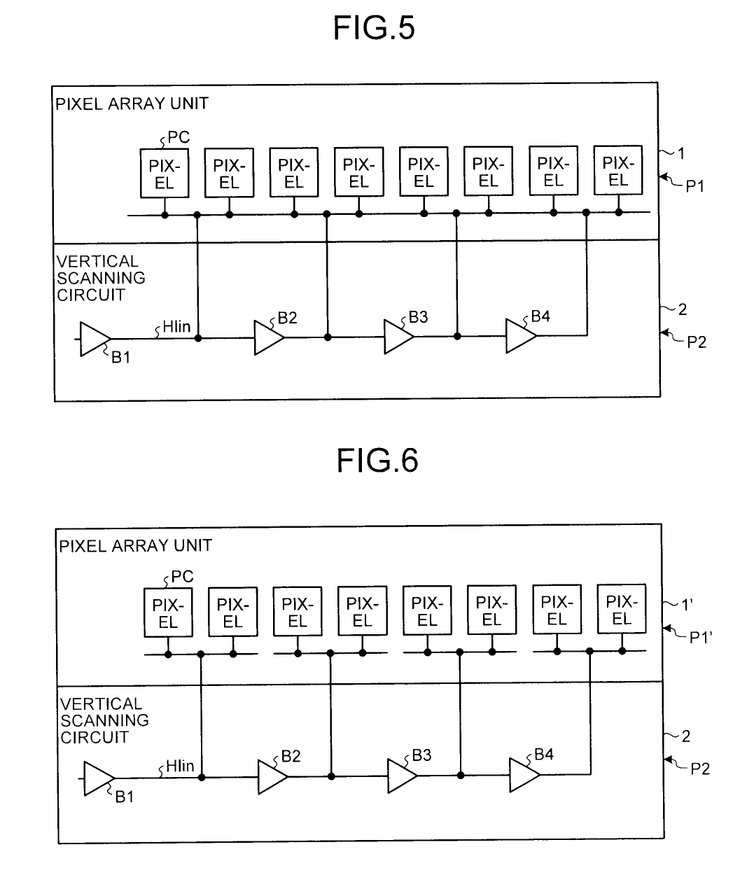

FIG. 5 is a block diagram of one example of a layered structure of one line of the pixel array unit and a vertical scanning circuit in the solid-state imaging device illustrated in FIG. 1.

Referring to FIG. 5, drivers B1 to B4 are inserted into the horizontal drive wire Hlin in each of the rows. The pixel array unit 1 is provided on the semiconductor chip P1. The horizontal drive wire Hlin and the drivers B1 to B4 are provided on the semiconductor chip P2. The semiconductor chip P1 is stacked on the semiconductor chip P2.

The read signal ΦD, the reset signal ΦR, and the row selection signal ΦA are sequentially amplified at the drivers B1 to B4 with increase in the transmission distance of the horizontal drive wire Hlin, and are supplied to the pixels PC. Accordingly, even if the horizontal drive wire Hlin becomes longer in distance, it is possible to reduce a load on the drivers B1 to B4 and shorten driving time.

FIG. 6 is a block diagram of a modification example of the layered structure illustrated in FIG. 5.

Referring to FIG. 6, a semiconductor chip P1′ is provided with a pixel array unit 1′. The semiconductor chip P1′ is stacked on a semiconductor chip P2. At the pixel array unit 1′, the horizontal drive wire Hlin is separated between the pixels PC for respective outputs of the drivers B1 to B4. This makes it possible to prevent outputs of the drivers B1 to B4 from interfering with each other.

In the examples of FIGS. 5 and 6, the drivers B1 to B4 are inserted one by one into the horizontal drive wire Hlin for two pixels PC each. Alternatively, the drivers may be inserted one by one into the horizontal drive wire Hlin for N (N is a positive integer) pixels PC each.

In addition, in the examples of FIGS. 5 and 6, the configuration of one line of the pixel array unit 1 or 1′ is exemplified. Other lines of the pixel array unit 1 or 1′ can be configured in the same manner.

### Second Embodiment

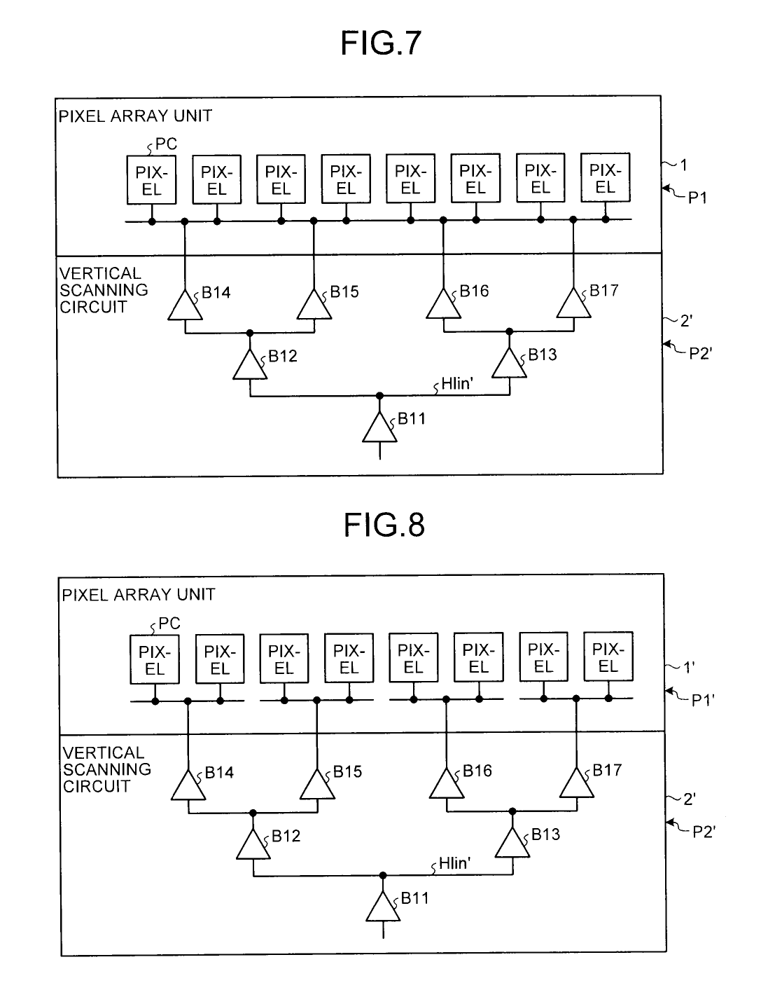

FIG. 7 is a block diagram of one example of a layered structure of one line of a pixel array unit and a vertical scanning circuit in a solid-state imaging device according to a second embodiment.

Referring to FIG. 7, in the solid-state imaging device, a vertical scanning circuit 2′ is provided instead of the vertical scanning circuit 2 illustrated in FIG. 5. The vertical scanning circuit 2′ is provided with horizontal drive wire Hlin′, and drivers B11 to B17 are inserted into the horizontal drive wire Hlin for each of the rows. The horizontal drive wire Hlin′ is branched such that the drivers B11 to B17 are inserted into branches of the horizontal drive wire Hlin′. That is, the horizontal drive wire Hlin′ has a tree structure and the drivers B11 to B17 are inserted into braches of the tree. The pixel array unit 1 is provided on the semiconductor chip P1. The horizontal drive wire Hlin′ and the drivers B11 to B17 are provided on the semiconductor chip P2′. The semiconductor chip P1 is stacked on the semiconductor chip P2′.

The read signal ΦD, the reset signal ΦR, and the row selection signal ΦA are sequentially amplified at the drivers B11 to B17 with increase in the branches of the horizontal drive wire Hlin′, and are supplied to the pixels PC. Accordingly, even if the horizontal drive wire Hlin′ becomes longer in distance, it is possible to reduce a load on the drivers B11 to B17 and shorten driving time. By providing the horizontal drive wire Hlin′ with a tree structure, it is possible to unify the numbers of stages of the drivers B11 to B17 through which the read signal TD, the reset signal TR, and the line selection signal TA can reach the pixels PC. This makes it possible to shorten a delay time taken for driving one line of the pixels PC, as compared to the configuration illustrated in FIG. 5.

FIG. 8 is a block diagram of a modification example of the layered structure illustrated in FIG. 7.

Referring to FIG. 8, the configuration of the solid-state imaging device is the same as that illustrated in FIG. 7, except that the semiconductor chip P1 illustrated in FIG. 7 is replaced with the semiconductor chip P1′ illustrated in FIG. 6. In this case, the horizontal drive wire Hlin′ can be separated for each of outputs of the drivers B14 to B17 at the final stage of the tree structure. In the examples of FIGS. 7 and 8, the configuration of one line of the pixel array unit 1 or 1′ is exemplified. Other lines of the pixel array unit 1 or 1′ can be configured in the same manner.

### Third Embodiment

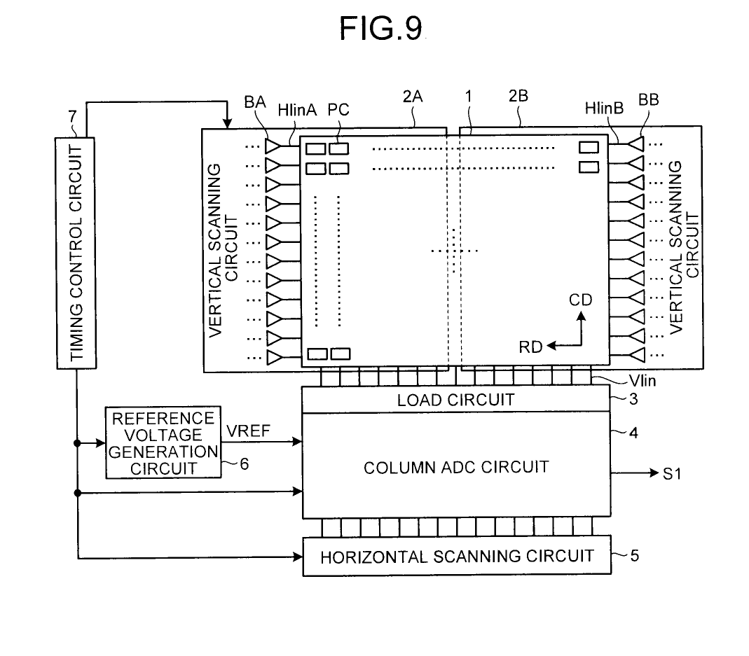

FIG. 9 is a schematic block diagram of a solid-state imaging device according to a third embodiment.

Referring to FIG. 9, in the solid-state imaging device, vertical scanning circuits 2A and 2B are provided instead of the vertical scanning circuit 2 illustrated in FIG. 1. The vertical scanning circuits 2A and 2B are provided with horizontal drive wires HlinA and HlinB, respectively. The vertical scanning circuits 2A and 2B are arranged on both sides of the pixel array unit 1. The vertical scanning circuit 2A can drive the pixels PC at the left section of the pixel array unit 1. The vertical scanning circuit 2B can drive the pixels PC at the right section of the pixel array unit 1. The vertical scanning circuit 2A has drivers BA for driving the pixels PC dispersed in each of the rows. The vertical scanning circuit 2B has drivers BB for driving the pixels PC dispersed in each of the rows. Pluralities of drivers BA and BB can be inserted into the horizontal drive wires HlinA and HlinB. At that time, the pixel array unit 1 can be stacked on the vertical scanning circuits 2A and 2B to provide the drivers BA and BB under the pixel array unit 1.

In addition, when the pixels PC are vertically scanned at the same timing at the vertical scanning circuits 2A and 2B, the pixels PC are selected in the row direction RD and the pixels PC are driven in each of the rows by the drivers BA and BB. Then, when, at the load circuit 3, a source follower operation is performed with the pixels PC to transmit pixels signals read from the pixels PC via the vertical signal wire Vlin and send the same to the column ADC circuit 4. In addition, at the reference voltage generation circuit 6, a ramp wave is set as reference voltage VREF and sent to the column ADC circuit 4. Then, at the column ADC circuit 4, a clock count operation is performed until the signal level and the reset level read from the pixels PC agree with the level of the ramp wave, and a difference is determined between the signal level and the reset level at that time to detect the signal components of the pixels PC by CDS, and outputs the same as an output signal S1.

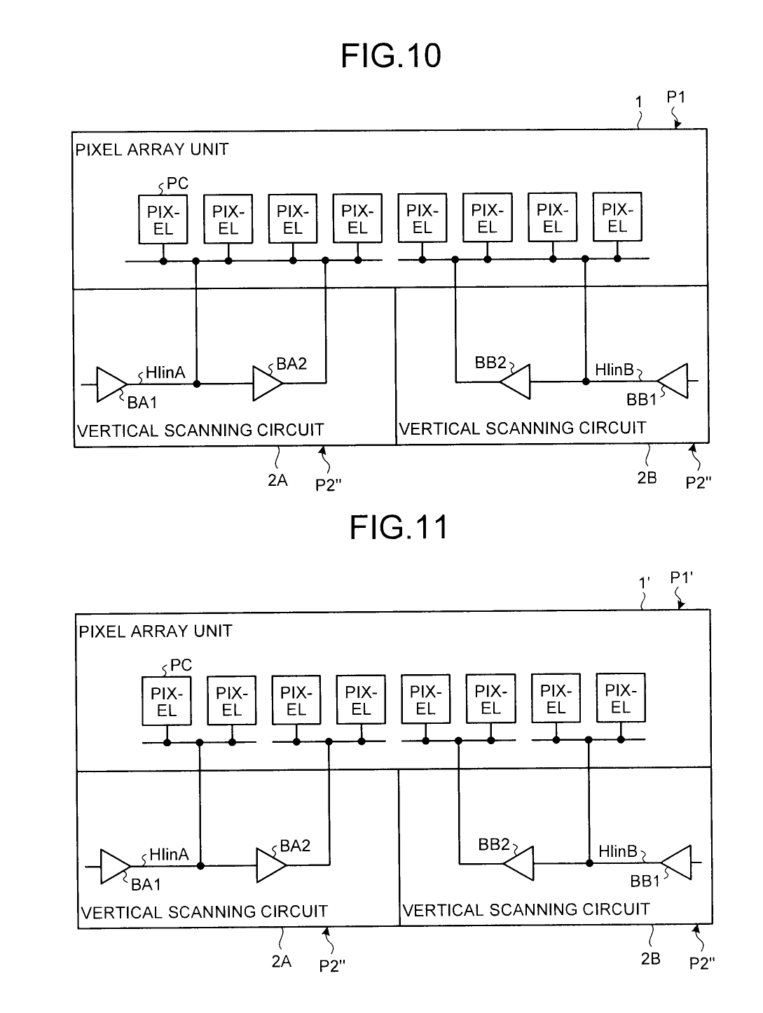

FIG. 10 is a block diagram of one example of a layered structure of one line of a pixel array unit and a vertical scanning circuit in the solid-state imaging device illustrated in FIG. 9.

Referring to FIG. 10, drivers BA1 and BA2 are inserted into the horizontal drive wire HlinA for each of the rows. Drivers BB1 and BB2 are inserted into the horizontal drive wire HlinB for each of the rows. The pixel array unit 1 is provided on the semiconductor chip P1. The horizontal drive wires HlinA and HlinB and the drivers BA1, BA2, BB1, and BB2 are provided on a semiconductor chip P2″. The semiconductor chip P1 is stacked on the semiconductor chip P2″.

The read signal OD, the reset signal ΦR, and the row selection signal ΦA are sequentially amplified at the drivers BA1 to BA2 with increase in the transmission distance of the horizontal drive wire HlinA, and are supplied to the pixels PC at the left section of the pixel array unit 1. In addition, the read signal ΦD, the reset signal ΦR, and the row selection signal ΦA are sequentially amplified at the drivers BB1 to BB2 with increase in the transmission distance of the horizontal drive wire HlinB, and are supplied to the pixels PC at the right section of the pixel array unit 1. Accordingly, even if the horizontal drive wires HlinA and HlinB become longer in distance, it is possible to reduce a load on the drivers BA1, BA2, BB1, and BB2 and shorten driving time.

FIG. 11 is a block diagram of a modification example of the layered structure illustrated in FIG. 10.

Referring to FIG. 11, the configuration of the solid-state imaging device is the same as that illustrated in FIG. 10, except that the semiconductor chip P1 illustrated in FIG. 10 is replaced with the semiconductor chip P1′ illustrated in FIG. 6.

In the examples of FIGS. 10 and 11, the drivers BA1, BA2, BB1, and BB2 are inserted one by one into the horizontal drive wires HlinA and HlinB for two pixels PC each. Alternatively, the drivers may be inserted one by one into the horizontal drive wires HlinA and HlinB for N (N is a positive integer) pixels PC each.

In the examples of FIGS. 10 and 11, the configuration of one line of the pixel array unit 1 or 1′ is exemplified. Other lines of the pixel array unit 1 or 1′ can be configured in the same manner.

In addition, in the examples of FIGS. 10 and 11, the drivers BA1, BA2, BB1, and BB2 are inserted into the horizontal drive wires HlinA and HlinB in a line form. Alternatively, the horizontal drive wires HlinA and HlinB may be configured in a tree form such that the drivers are Inserted into branches.

### Fourth Embodiment

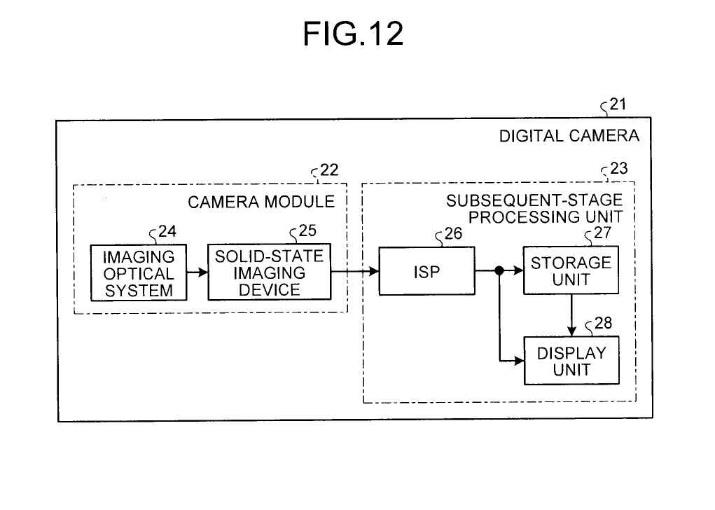

FIG. 12 is a schematic block diagram of a digital camera to which a solid-state imaging device according to a fourth embodiment is applied.

Referring to FIG. 12, a digital camera 21 has a camera module 22 and a subsequent-stage processing unit 23. The camera module 22 has an imaging optical system 24 and a solid-state imaging device 25. The subsequent-stage processing unit 23 has an image signal processor (ISP) 26, a storage unit 27, and a display unit 28. The solid-state imaging device 25 may have the configuration illustrated in FIG. 1 or 9. At least portion of the ISP 26 may be configured to form one chip together with the solid-state imaging device 25.

The imaging optical system 24 captures light from a subject and forms an image of the subject. The solid-state imaging device 25 takes the image of the subject. The ISP 26 processes an image signal obtained from the imaging at the solid-state imaging device 25. The storage unit 27 stores the image having undergone the signal processing at the ISP 26. The storage unit 27 outputs the image signal to the display unit 28 according to the user's operation or the like. The display unit 28 displays the image according to the image signal input from the ISP 26 or the storage unit 27. The display unit 28 is a liquid crystal display, for example. The camera module 22 may be applied to not only the digital camera 21 but also electronic devices such as a camera-equipped mobile phone or a smart phone, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device, comprising:
a pixel array unit in which pixels for accumulating photoelectric-converted charges are arranged in a matrix of a row direction and a column direction; and
a vertical scanning circuit in which drivers for driving the pixels are dispersed in each of rows.

2. The solid-state imaging device according to claim 1, comprising a horizontal drive wire that drives the pixels in each of the rows, wherein
a plurality of the drivers is inserted into the horizontal drive wire.

3. The solid-state imaging device according to claim 2, wherein the drivers are connected in series on the horizontal drive wire.

4. The solid-state imaging device according to claim 3, wherein the horizontal drive wire is separated for each of outputs of the drivers.

5. The solid-state imaging device according to claim 1, wherein
the horizontal drive wire is configured to be branched, and
the drivers are inserted into each of branches of the horizontal drive wire.

6. The solid-state imaging device according to claim 5, wherein the horizontal drive wire has a tree structure.

7. The solid-state imaging device according to claim 6, wherein the horizontal drive wire is separated for each of the outputs of the drivers at a final stage of the tree structure.

8. The solid-state imaging device according to claim 1, wherein
the pixel array unit is formed on a first semiconductor chip,
the vertical scanning circuit is formed on a second semiconductor chip, and
the first semiconductor chip is stacked on the second semiconductor chip.

9. The solid-state imaging device according to claim 1, wherein
the pixels includes:
a photodiode that accumulates photoelectric-converted charges;
a row selection transistor that selects the pixels in the row direction;
an amplification transistor that detects a signal read from the photodiode;
a reset transistor that resets a signal read from the photodiode; and
a read transistor that reads a signal from the photodiode.

10. The solid-state imaging device according to claim 8, wherein the vertical scanning circuit outputs a read signal, a reset signal, and a row selection signal to the pixels in each of the rows.

11. A solid-state imaging device, comprising:
a pixel array unit in which pixels for accumulating photoelectric-converted charges are arranged in a matrix of a row direction and a column direction;
a first vertical scanning circuit in which first drivers for driving the pixels are dispersed in each of rows to drive the pixels at the left section of the pixel array unit and;
a second vertical scanning circuit in which second drivers for driving the pixels are dispersed in each of the rows to drive the pixels at the right section of the pixel array unit.

12. The solid-state imaging device according to claim 11, comprising
a first horizontal drive wire that drives the pixels in each of the rows at the left section of the pixel array unit; and
a second horizontal drive wire that drives the pixels in each of the rows at the right section of the pixel array unit, wherein
a plurality of the first drivers is inserted into the first horizontal drive wire, and
a plurality of the second drivers is inserted into the second horizontal drive wire.

13. The solid-state imaging device according to claim 12, wherein
the first drivers are connected in series on the first horizontal drive wire, and
the second drivers are connected in series on the second horizontal drive wire.

14. The solid-state imaging device according to claim 13, wherein
the first horizontal drive wire is separated for each of outputs of the first drivers, and
the second horizontal drive wire is separated for each of outputs of the second drivers.

15. The solid-state imaging device according to claim 11, wherein
the first horizontal drive wire is branched,
the first drivers are inserted into each of branches of the first horizontal drive wire,
the second horizontal drive wire is branched, and
the second drivers are inserted into each of branches of the second horizontal drive wire.

16. The solid-state imaging device according to claim 15, wherein
the first horizontal drive wire has a first tree structure, and
the second horizontal drive wire has a second tree structure.

17. The solid-state imaging device according to claim 16, wherein
the first horizontal drive wire is separated for each of outputs of the first drivers at a final stage of the first tree structure, and
the second horizontal drive wire is separated for each of outputs of the second drivers at a final stage of the second tree structure.

18. The solid-state imaging device according to claim 11, wherein
the pixel array unit is formed on the first semiconductor chip,
the first vertical scanning circuit is formed on the second semiconductor chip,
the second vertical scanning circuit is formed on the third semiconductor chip, and
the first semiconductor chip is stacked on the second semiconductor chip and the third semiconductor chip.

19. The solid-state imaging device according to claim 11, wherein
the pixels includes:
a photodiode that accumulates photoelectric-converted charges;
a row selection transistor that selects the pixels in the row direction;
an amplification transistor that detects a signal read from the photodiode;
a reset transistor that resets a signal read from the photodiode; and
a read transistor that reads a signal from the photodiode.

20. The solid-state imaging device according to claim 18, wherein
the first vertical scanning circuit outputs a read signal, a reset signal, and a row selection signal to the pixels in each of the rows at the left section of the pixel array unit, and
the second vertical scanning circuit outputs a read signal, a reset signal, and a row selection signal to the pixels in each of the rows at the right section of the pixel array unit.
